(19) United States
(12) Patent Application Publication
(10) Pub. No.: US 2020/0308043 A1
(43) Pub. Date: Oct. 1, 2020

(54) OPTICAL FIBER DRAWING FURNACE HEATING ELEMENT, OPTICAL FIBER DRAWING FURNACE, AND METHOD FOR MANUFACTURING OPTICAL FIBER

(71) Applicant: Fujikura Ltd., Tokyo (JP)

(72) Inventors: Takayuki Kitamura, Chiba (JP); Nobuo Ozeki, Chiba (JP); Katsuhiro Takenaga, Chiba (JP)

(73) Assignee: Fujikura Ltd., Tokyo (JP)

(21) Appl. No.: 16/832,680

(22) Filed: Mar. 27, 2020

(30) Foreign Application Priority Data
Mar. 29, 2019 (JP) 2019-068950

(51) Int. Cl. C03B 37/029; C03B 37/03; C03B 37/023

(52) U.S. Cl. CPC C03B 37/029; C03B 37/0235; C03B 37/032

(57) ABSTRACT

An optical fiber drawing furnace heating element includes a heat generator including: a tubular resistance heating element in which at least a part of an optical fiber preform is disposed in a through-hole; a first portion extending, from a first end portion, over a predetermined section along a longitudinal direction; and a second portion disposed closer to a second end portion than the first portion. The second portion has a wall thickness on a side of the first end portion being equal to or larger than a wall thickness of the first portion. The wall thickness of the second portion increases toward a side of the second end portion from the side of the first end portion.

### BACKGROUND

The present invention relates to an optical fiber drawing furnace heating element, an optical fiber drawing furnace, and a method for manufacturing an optical fiber.

An optical fiber is manufactured by drawing an optical fiber preform having a cross-sectional structure substantially similar to that of the optical fiber. Patent Literature 1 below describes a heating element used in a drawing furnace for drawing an optical fiber. This heating element, which is of a resistance heating type, is formed to have a substantially tubular shape as a whole with graphite in a meandering form having a certain thickness formed. In a region surrounded by this heating element, the temperature is substantially uniform along the drawing direction.
[Patent Literature 1] Japanese Patent No. 5557866 B2

In order to increase the optical transmission distance and increase the optical transmission speed in an optical fiber communication system, a higher optical signal-to-noise ratio is required, meaning that optical fibers with small transmission loss are required. Highly sophisticated optical fiber manufacturing methods that are currently available is anticipated to have reached almost the smallest possible transmission loss due to impurities. The remaining main cause of the transmission loss is scattering loss due to variations in the structure and/or the composition of glass forming the optical fibers. This is inevitable because optical fibers are made of glass.

One known method for reducing the variation in the glass structure features slow cooling of molten glass. Attempts for such slow cooling of molten glass include slowly cooling an optical fiber immediately after being drawn from a drawing furnace. Approaches under consideration for slowing down the cooling rate of the optical fiber include heating the optical fiber drawn from the drawing furnace in a slow cooling furnace. The drawing furnace using a heating element disclosed in Patent Literature 1 described above also requires a bare optical fiber, drawn with heat from this heating element, to be heated in a slow cooling furnace, to reduce the variation in the glass structure.

However, an optical fiber manufacturing facility including both a drawing furnace and a slow cooling furnace involves a concern that configuration thereof is complex because the heating elements are required for each of the drawing furnace and the slow cooling furnace.

### SUMMARY

Embodiments of the present invention provide an optical fiber drawing furnace heating element, an optical fiber drawing furnace, and a method for manufacturing an optical fiber that may achieve an optical fiber drawing furnace that may manufacture an optical fiber with a smaller transmission loss with a simple configuration.

An optical fiber drawing furnace heating element according to one or more embodiments of the present invention includes a heat generating unit (heat generator) including a tubular resistance heating element in which at least a part of an optical fiber preform is disposed in a through-hole. The heat generating unit includes a first portion extending, from a first end portion of the heat generating unit, over a predetermined section along a longitudinal direction of the optical fiber drawing furnace heating element and a second portion positioned closer to a second end portion of the heat generating unit than the first portion is. The second portion has a wall thickness on a side of the first end portion being equal to or larger than a wall thickness of the first portion, the wall thickness of the second portion increasing toward a side of the second end portion from the side of the first end portion.

In such an optical fiber drawing furnace heating element, when the same amount of current flows through the first portion and the second portion, in the first portion with the wall thickness equal to or smaller than the minimum wall thickness of the second portion, current density equal to or higher than that in the second portion is achieved, and thus temperature that is equal to or higher than that in the second portion is achieved. Thus, even when voltage is applied to the optical fiber drawing furnace heating element so as to generate heat until the temperature at which the optical fiber preform is drawn in the first portion is reached, the temperature on the first end portion side in the second portion would not exceed the temperature of the first portion. Furthermore, with the current density decreasing toward the second end portion side from the first end portion side in the second portion, heat is generated with the temperature decreasing toward the second end portion side from the first end portion side. Thus, the temperature of the bare optical fiber drawn in the first portion can be gradually lowered in the second portion. In other words, the bare optical fiber can be slowly cooled in the second portion. The optical fiber drawing furnace heating element according to one or more embodiments of the present invention includes the first portion with which the bare optical fiber may be drawn in this manner, and the second portion in which the bare optical fiber drawn may be slowly cooled. Thus, the optical fiber drawing furnace heating element according to one or more embodiments of the present invention can be applied to an optical fiber drawing furnace to achieve an optical fiber drawing furnace with which an optical fiber with a smaller transmission loss can be manufactured with a simpler configuration than that in a case where the drawing furnace and the slow cooling furnace are separately provided.

In one or more embodiments, the wall thickness of the second portion continuously changes toward the side of the second end portion from the side of the first end portion.

With such a configuration, the temperature of the second portion is less likely to sharply change locally, compared with a case where the wall thickness of the second portion changes stepwise toward the second end portion side from the first end portion side.

In one or more embodiments, the wall thickness of the second portion changes at a smaller rate at a portion closer to the second end portion.

With such a configuration, the current density can be gradually decreased toward the second end portion side the second portion, and thus the temperature can be gradually lowered toward the second end portion side of the second portion. Accordingly, the temperature of the bare optical fiber can be lowered more gradually at a portion closer to the end of the process of slowly cooling the bare optical fiber. Thus, the temperature drop of the bare optical fiber can be gradually controlled so that the fictive temperature, indicating the disorderly of the glass structure, can be set to be minimum in accordance with the glass structural relaxation rate decreasing with the temperature drop of the bare optical fiber.

The second portion may have a uniform inner diameter.

In such a case, the through-hole in the second portion can be perforated with a generally used drill or the like, whereby the inner circumference surface of the second portion can be easily formed. Thus, the optical fiber drawing furnace heating element according to one or more embodiments of the present invention can be easily obtained.

In one or more embodiments, in the second portion, an inner diameter closer to the second end portion is smaller than inner diameter closer to the first end portion.

Inert gas is likely to flow in the through-hole of the optical fiber drawing furnace heating element. In view of this, with the configuration described above, the inert gas flowing in the through-hole may be rectified, so that the bare optical fiber drawn can be suppressed from unnecessarily moving. Thus, an optical fiber drawing furnace heating element that may be capable of manufacturing an optical fiber with stable characteristics may be obtained.

The second portion may have a uniform outer diameter.

In such a case, the outer circumference surface of the second portion can be easily formed. Thus, the optical fiber drawing furnace heating element according to one or more embodiments of the present invention can be easily obtained.

The second portion may have a uniform inner diameter from an intermediate point toward the second end portion from the first end portion.

With this configuration, the inner diameter of the second portion can be reduced to be suitable for a shape known as neck down as a result of the optical fiber preform drawn to go through diameter reduction to be the bare optical fiber. In view of this, with the configuration described above, the inert gas flowing in the through-hole may be more effectively rectified, so that the bare optical fiber drawn can be more effectively prevented from unnecessarily moving. Thus, an optical fiber drawing furnace heating element that may be capable of manufacturing an optical fiber with more stable characteristics may be obtained.

In one or more embodiments, the first portion may have a uniform wall thickness over the longitudinal direction.

With such a configuration, in the first portion in which the optical fiber preform may be drawn into the bare optical fiber, the heat generation with a uniform temperature along the longitudinal direction may be achieved. In this context, a temperature distribution needs to be maintained to be constant because the shape known as neck down depends on the viscosity and the drawing tension of glass in the portion. Thus, with the uniform temperature of the heating element achieved with the configuration described above, one of the parameters that need to be controlled can be eliminated, meaning that the neck-down shape can be more easily maintained constantly. Thus, the outer diameter of the bare optical fiber is less likely to vary unnecessarily.

In one or more embodiments, the heat generating unit includes a third portion that is provided between the first portion and the second portion and has a wall thickness that is larger than the maximum of wall thickness of the second portion.

With such a configuration, the temperature of the third portion can be made lower than those in the first portion and the second portion. Thus, the bare optical fiber drawn is pre-cooled in the third portion to have temperature suitable for the bare optical fiber to enter the second portion.

In this case, in the third portion, an inner diameter closer to the second end portion is preferably smaller than inner diameter closer to the first end portion.

As described above, inert gas is likely to flow in the through-hole of the optical fiber drawing furnace heating element. In view of this, with the configuration described above, the inert gas flowing in the through-hole may be rectified, so that the bare optical fiber drawn can be suppressed from unnecessarily moving. Thus, an optical fiber drawing furnace heating element that may be capable of manufacturing an optical fiber with stable characteristics may be obtained.

In one or more embodiments, a pair of power feeding units (power feeds) include the resistance heating element and are provided at both ends of a tubular shape of the heat generating unit in the longitudinal direction. One of the power feeding units that is on the side of the second end portion of the heat generating unit has a wall thickness that is equal to or larger than a maximum wall thickness of the second portion.

With such a configuration, the optical fiber that has reached a low fictive temperature in the second portion is less likely to be heated again in the power feeding unit at the lower end. Thus, the fictive temperature is less likely to rise.

An optical fiber drawing furnace according to one or more embodiments of the present invention includes any of the above-described optical fiber drawing furnace heating element.

Thus, the optical fiber drawing furnace heating element according to one or more embodiments of the present invention can achieve an optical fiber drawing furnace with which an optical fiber with a smaller transmission loss can be manufactured with a simpler configuration than that in a case where the drawing furnace and the slow cooling furnace are separately provided. Thus, an optical fiber drawing furnace including this optical fiber drawing furnace heating element can perform drawing and slow cooling with a simpler configuration that that in a case where the drawing furnace and the slow cooling furnace are separately provided.

A method for manufacturing an optical fiber according to one or more embodiments of the present invention includes: a drawing process of drawing the optical fiber preform disposed in the through-hole in the first portion in the optical fiber drawing furnace heating element of the above-described optical fiber drawing furnace; and a slow cooling process of slowly cooling the bare optical fiber, drawn in the drawing process, in the through-hole in the second portion in the optical fiber drawing furnace heating element.

Thus, the optical fiber drawing furnace according to one or more embodiments of the present invention can perform drawing and slow cooling with a simpler configuration that that in a case where the drawing furnace and the slow cooling furnace are separately provided. Thus, with the method for manufacturing an optical fiber according to one or more embodiments of the present invention, the drawing process and the slow cooling process can be implemented with simpler configuration.

In one or more embodiments, temperature of the bare optical fiber entering the second portion is equal to or higher than 1300° C. and is equal to or lower than 1650° C., and temperature of the bare optical fiber exiting from the second portion is equal to or higher than 1150° C. and is lower than 1400° C.

With the temperature of the optical fiber entering the second portion and the temperature of the optical fiber exiting from the second portion thus appropriately controlled, the structural relaxation of glass constituting the optical fiber can be promoted in the second portion. As a result, the scattering loss occurring when transmitting light due to the variation of the glass structure is suppressed, whereby an optical fiber with a smaller transmission loss can be achieved.

In addition, cooling time of the bare optical fiber in the second portion is preferably 0.05 seconds or more.

With this configuration, the structural relaxation of the glass constituting the optical fiber can be more easily promoted in the second portion.

Cooling time of the bare optical fiber in the second portion is preferably 1 second or less.

A longer slow cooling time leads to more structural relaxation of glass, resulting in a smaller transmission loss, but this effect drastically decreases. In view of this, the slow cooling time for the optical fiber set to be 1 second or shorter can enable the second portion to be short or provide other like effects contributing to reduction of the capital investment cost. With the time during which the optical fiber stays in the second portion set to be a short period of time not exceeding 1 second, the drawing speed can be increased, whereby the structural relaxation of the glass constituting the bare optical fiber can be promoted without sacrificing productivity.

In one or more embodiments, the heat generating unit includes a third portion that is provided between the first portion and the second portion and has a wall thickness that is larger than the wall thickness of the second portion on the side of the first end portion, and the method further includes a pre-cooling process of cooling, with the third portion, the optical fiber to temperature suitable for the optical fiber to enter the second portion.

In one or more embodiments, the temperature of the bare optical fiber entering the second portion is limited within a predetermined range. In view of this, with the pre-cooling process described above further provided, the temperature of the optical fiber entering the second portion can be more easily adjusted to be in an appropriate range.

As described above, embodiments of the present invention can provide an optical fiber drawing furnace heating element, an optical fiber drawing furnace, and a method for manufacturing an optical fiber that may achieve an optical fiber drawing furnace that may manufacture an optical fiber with a smaller transmission loss with a simple configuration.

### BRIEF DESCRIPTION OF DRAWINGS

FIG. 1 is a diagram schematically illustrating a configuration of an optical fiber manufacturing apparatus according to one or more embodiments;

FIG. 2 is a sectional view illustrating a configuration of an optical fiber drawing furnace in FIG. 1;

FIG. 3 is a perspective view illustrating a configuration of an optical fiber drawing furnace heating element according to one or more embodiments;

FIG. 4 is a flowchart illustrating processes of an optical fiber manufacturing method according to one or more embodiments of the present invention;

FIG. 5 is a graph illustrating the relationship between the temperature of an optical fiber, the fictive temperature of glass constituting the optical fiber, and the cooling time according to one or more embodiments;

FIG. 6 is a graph illustrating the relationship between a change in the outer diameter of a neck-down portion, a change in the temperature of the optical fiber, and a change in the fictive temperature of the glass constituting the optical fiber according to one or more embodiments;

FIG. 7 is a sectional view illustrating a first modification of the optical fiber drawing furnace heating element according to one or more embodiments;

FIG. 8 is a sectional view illustrating a second modification of the optical fiber drawing furnace heating element according to one or more embodiments;

FIG. 9 is a sectional view illustrating a third modification of the optical fiber drawing furnace heating element according to one or more embodiments;

FIG. 10 is a sectional view illustrating a fourth modification of the optical fiber drawing furnace heating element according to one or more embodiments; and

FIG. 11 is a sectional view illustrating a fifth modification of the optical fiber drawing furnace heating element according to one or more embodiments.

### DETAILED DESCRIPTION

Hereinafter, an optical fiber manufacturing method according to one or more embodiments of the present invention will be described in detail with reference to the drawings.

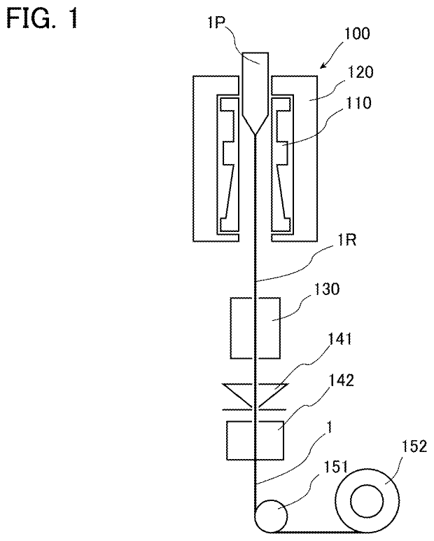

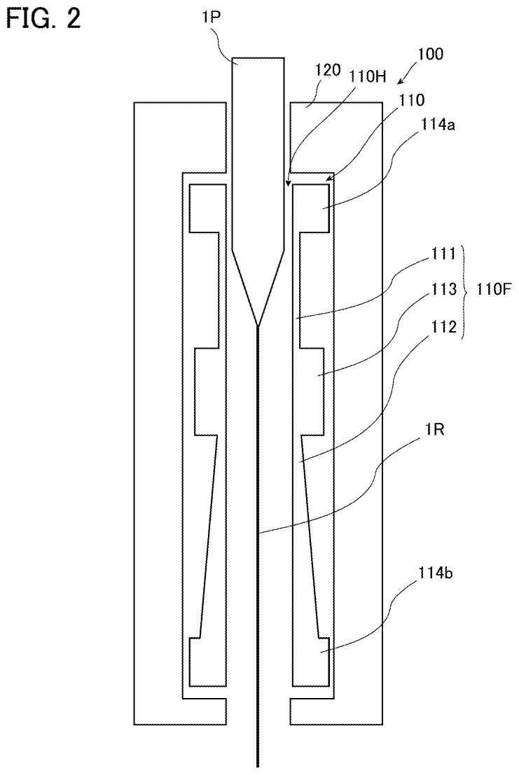

FIG. 1 is a diagram schematically illustrating a configuration of an optical fiber manufacturing apparatus for use in the optical fiber manufacturing method according to one or more embodiments. As illustrated in FIG. 1, the optical fiber manufacturing apparatus includes an optical fiber drawing furnace 100. FIG. 2 is a sectional view illustrating a configuration of the optical fiber drawing furnace 100 in FIG. 1. As illustrated in FIGS. 1 and 2, the optical fiber drawing furnace 100 includes an optical fiber drawing furnace heating element 110 and a heat insulating unit 120.

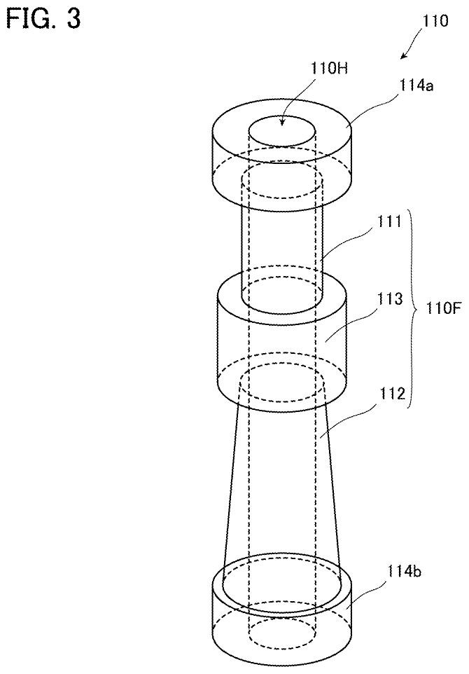

FIG. 3 is a perspective view illustrating the optical fiber drawing furnace heating element 110 according to one or more embodiments. As illustrated in FIGS. 2 and 3, the optical fiber drawing furnace heating element 110 includes a heat generating unit (heat generator) 110F and a pair of power feeding units (power feeds) 114a and 114b provided at both ends of the heat generating unit 110F. The heat generating unit 110F includes a first portion 111, a second portion 112, and a third portion 113. This optical fiber drawing furnace heating element 110 is made of a resistance heating element that generates heat due to resistance while a current is flowing, and the pair of power feeding units 114a and 114b, the first portion 111, the second portion 112, and the third portion 113 are formed by integral molding. Examples of such resistance heating elements include non-metallic heating elements such as graphite, silicon carbide, and silicon nitride, and other ceramic heaters such as zirconia, and alumina. Of these, graphite is preferable in terms of easy cutting and excellent workability.

One power feeding unit 114a is provided at a first end portion of the optical fiber drawing furnace heating element 110. The power feeding unit 114a has a through-hole 110H at a center of the power feeding unit 114a and has a ring shape with a constant thickness. A power supply (not illustrated) is connected to the power feeding unit 114a.

The first portion 111 is provided next to the power feeding unit 114a. Thus, an end portion of the first portion 111 on the power feeding unit 114a side is the first end portion of the heat generating unit 110F. The first portion 111 according to one or more embodiments has a cylindrical shape with a constant wall thickness, and occupies a predetermined section along a longitudinal direction of the optical fiber drawing furnace heating element 110 from the first end portion of the heat generating unit 110F. The inner diameter of the first portion 111 is as large as the inner diameter of the power feeding unit 114a, and the through-hole 110H extends in the first portion 111 as well. A wall thickness of the first portion 111 along a radial direction of the first portion 111 is smaller than a wall thickness of the power feeding unit 114a along a radial direction of the power feeding unit 114a. Therefore, an outer diameter of the first portion 111 is smaller than an outer diameter of the power feeding unit 114a. The first portion 111 generates heat from current up to the point where a bare optical fiber 1R is drawn from an optical fiber preform 1P disposed in the through-hole 110H. That is, the first portion 111 is a portion where the bare optical fiber 1R is drawn from the optical fiber preform 1P disposed in the through-hole 110H. It is noted that an inner diameter of a portion of the optical fiber drawing furnace heating element 110 is a diameter of an inner wall surface in the portion, an outer diameter of a portion of the optical fiber drawing furnace heating element 110 is a diameter of an outer wall surface of the portion, and a wall thickness of a portion of the optical fiber drawing furnace heating element 110 is the difference between an outer diameter and an inner diameter of the portion.

The third portion 113 is provided next to the first portion 111 on the side opposite to the power feeding unit 114a side. The third portion 113 has a ring shape, and the through-hole 110H extends in the third portion 113 as well. An inner diameter of the third portion 113 is constant along the longitudinal direction and is as large as the inner diameter of the first portion 111. Furthermore, a wall thickness of the third portion 113 along a radial direction of the third portion 113 is constant along the longitudinal direction, and is larger than the wall thickness of the first portion 111 along the radial direction of the first portion 111. Therefore, an outer diameter of the third portion 113 is constant along the longitudinal direction and is larger than the outer diameter of the first portion 111. When the same amount of current as that flowing through the first portion 111 flows through the third portion 113 with the above-described configuration, the current density in the third portion 113 is lower than the current density in the first portion 111. Accordingly, when the same amount of current flows through the first portion 111 and the third portion 113, the third portion 113 generates heat at temperature lower than the temperature of heat generated in the first portion 111, and the temperature in the through-hole 110H of the third portion 113 is lower than the temperature in the through-hole 110H of the first portion 111. Therefore, the third portion 113 can cool the bare optical fiber 1R drawn in the first portion 111. That is, the third portion 113 is a portion where the bare optical fiber 1R drawn is pre-cooled.

The second portion 112 is provided next to the third portion 113 on the side opposite to the first portion 111 side. The second portion 112 has a cylindrical shape with a wall thickness of the second portion 112 changing along the longitudinal direction, and the through-hole 110H extends in the second portion 112 as well. An inner diameter of the second portion 112 is as large as the inner diameter of the third portion 113 and is constant along the longitudinal direction. A wall thickness on the side of a first end portion of the second portion 112 along a radial direction of the second portion 112 is equal to or larger than the wall thickness of the first portion 111 along the radial direction of the first portion 111 and is smaller than the wall thickness of the third portion 113 along the radial direction of the third portion 113. Furthermore, the wall thickness of the second portion 112 increases from the side of the first end portion toward the side of a second end portion. Thus, an outer diameter on the side of the first end portion of the second portion 112 is equal to or larger than the outer diameter of the first portion 111 and smaller than the outer diameter of the third portion 113, and an outer diameter on the side of the second end portion of the second portion 112 is larger than the outer diameter of the first portion 111. In one or more embodiments, the rate of change of the wall thickness from the side of the first end portion toward the side of the second end portion of the second portion 112 is constant. That is, the wall thickness of the second portion 112 monotonically increases from the side of the first end portion toward the side of the second end portion. When the same amount of current as that flowing through the first portion 111 flows through the second portion 112 with the above-described configuration, the current density on the side of the first end portion of the second portion 112 is equal to or lower than the current density in the first portion 111, and the current density monotonically decreases from the side of the first end portion toward the side of the second end portion of the second portion 112. Therefore, when the same amount of current flows through the first portion 111 and the second portion 112, the side of the first end portion of the second portion 112 generates heat at temperature equal to or lower than the temperature of heat generated in the first portion 111, and the second portion 112 generates heat so that the temperature monotonically decreases from the side of the first end portion to the side of the second end portion. Therefore, the second portion 112 can gradually cool the bare optical fiber 1R passing through the second portion 112. That is, the second portion 112 is a portion where the bare optical fiber 1R drawn is slowly cooled.

The power feeding unit 114b is provided next to the second portion 112 on the side of the second end portion. The configuration of the power feeding unit 114b is the same as that of the power feeding unit 114a. Thus, the through-hole 110H extends from the power feeding unit 114a to the power feeding unit 114b. A wall thickness of the power feeding unit 114b along a radial direction of the power feeding unit 114b is equal to or larger than the wall thickness at the second end portion of the second portion 112 along the radial direction. A power supply (not illustrated) is connected to the power feeding unit 114b.

In the optical fiber drawing furnace heating element 110 configured as described above, the power feeding unit 114a, the first portion 111, the third portion 113, the second portion 112, and the power feeding unit 114b are electrically connected in series. Accordingly, when a voltage is applied to the power feeding units 114a and 114b, the same amount of current flows through the first portion 111, the third portion 113, and the second portion 112.

The optical fiber drawing furnace heating element 110 is surrounded by the heat insulating unit 120. The heat insulating unit 120 is made of, for example, ceramic.

Next, an optical fiber manufacturing method using the optical fiber manufacturing apparatus illustrated in FIG. 1 will be described.

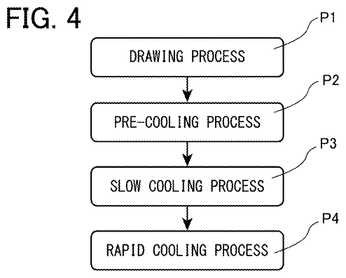

FIG. 4 is a flowchart illustrating processes of the optical fiber manufacturing method according to one or more embodiments. As illustrated in FIG. 4, the optical fiber manufacturing method according to one or more embodiments includes a drawing process P1, a pre-cooling process P2, a slow cooling process P3, and a rapid cooling process P4. Hereinafter, each of these processes will be described.

<Drawing Process P1>

This process is a process of drawing one end of the optical fiber preform 1P in the first portion 111. First, the optical fiber preform 1P made of glass having a refractive index profile similar to the refractive index profile of the glass constituting a final product optical fiber is prepared. The optical fiber has one or more cores and a clad that surrounds the outer circumferential surface of the core without any gap, and the refractive index of the core is higher than the refractive index of the clad. For example, when the core is made of silica glass to which a dopant such as germanium is added for enhancing the refractive index, the clad is made of pure silica glass. For example, when the core is made of pure silica glass, the clad is made of silica glass to which a dopant such as fluorine is added for lowering the refractive index.

Next, the optical fiber preform 1P is suspended so that the longitudinal direction is vertical. Then, the optical fiber preform 1P is placed in the optical fiber drawing furnace 100. Specifically, as illustrated in FIG. 2, the optical fiber preform 1P is placed such that a distal end of the optical fiber preform 1P is positioned in the through-hole 110H of the first portion 111 in the optical fiber drawing furnace heating element 110. Then, inert gas such as helium or argon flows through the through-hole of the optical fiber drawing furnace heating element 110.

Next, a voltage is applied from a power supply (not illustrated) so that a current flows between the pair of power feeding units 114a and 114b. Then, the optical fiber drawing furnace heating element 110 made of a resistance heating element generates heat due to electric resistance. In this process, as described above, since the first portion 111, the third portion 113, and the second portion 112 are connected in series, the same amount of current flows through the first portion 111, the third portion 113, and the second portion 112, and the first portion 111, the third portion 113, and the second portion 112 generate heat. Due to the heat from the first portion 111, a lower end of the optical fiber preform 1P is heated. At this time, the lower end of the optical fiber preform 1P is heated to, for example, 2000° C. to be in a molten state. That is, a voltage is applied across the pair of power feeding units 114a and 114b so that a current that causes the lower end of the optical fiber preform 1P to reach such temperature flows through the first portion 111. Then, the molten glass is drawn from the lower end of the heated optical fiber preform 1P at a predetermined drawing speed. The glass thus drawn becomes the bare optical fiber 1R.

<Pre-Cooling Process P2>

This process is a process of cooling the bare optical fiber 1R so that the bare optical fiber 1R drawn from the optical fiber preform 1P in the first portion 111 in the drawing process P1 has a predetermined temperature suitable for entering the second portion 112. This process is performed in the third portion 113. As described above, since the same amount of current flows through the first portion 111 and the third portion 113, the third portion 113 generates heat at temperature lower than the temperature of heat generated in the first portion 111. For this reason, the bare optical fiber 1R led out from the first portion 111 in the through-hole 110H is cooled when passing through the through-hole 110H in the third portion 113. Since the third portion 113 is connected to the first portion 111, the atmosphere in the through-hole 110H is substantially the same in the first portion 111 and the third portion 113. For this reason, a rapid change in the temperature around the bare optical fiber 1R immediately after the drawing is suppressed.

Providing this process makes it easy to adjust the cooling rate of the bare optical fiber 1R and adjust the temperature at which the bare optical fiber 1R enters the second portion 112 to an appropriate range. As will be described later, the temperature of the bare optical fiber 1R drawn from the first portion 111 can be estimated from the shape of the neck-down portion. Then, the length of the third portion 113 can be designed as appropriate based on the temperature of the bare optical fiber 1R thus estimated and the temperature of the bare optical fiber 1R suitable for entering the second portion 112.

<Slow Cooling Process P3>

This process is a process of gradually cooling, in the second portion 112, the bare optical fiber 1R drawn from the first portion 111 in the drawing process P1 and adjusted to a predetermined temperature in the third portion 113 in the pre-cooling process P2. The inside of the second portion 112 is set to temperature different from the temperature of the entering bare optical fiber 1R. As described above, the side of the first end portion of the second portion 112 generates heat at temperature equal to or lower than the temperature of heat generated in the first portion 111 and higher than the temperature of heat generated in the third portion 113, and the second portion 112 generates heat so that the temperature monotonically decreases from the side of the first end portion to the side of the second end portion. Accordingly, the temperature of the bare optical fiber 1R passing through the second portion 112 gradually decreases. Therefore, the structure of the glass constituting the bare optical fiber 1R relaxes, and an optical fiber with reduced scattering loss can be obtained.

Here, the temperature when the bare optical fiber 1R enters the second portion 112, the temperature when it exits from the second portion 112, and the time spent in the second portion 112 will be described.

If the temperature at the start of slow cooling of the bare optical fiber 1R is excessively high, the structural relaxation rate of the glass constituting the bare optical fiber 1R is so fast that the effect of slow cooling of the bare optical fiber 1R will be insufficient. On the other hand, if the temperature at the start of slow cooling of the bare optical fiber 1R is excessively low, the structural relaxation rate the glass constituting the bare optical fiber 1R becomes slow, which requires the re-heating of the bare optical fiber 1R in slow cooling, for example. Therefore, in order to promote the structural relaxation of the glass constituting the bare optical fiber 1R in the second portion 112, the temperature of the bare optical fiber 1R entering the second portion 112 and the temperature of the bare optical fiber 1R exiting from the second portion 112 are preferably controlled within a suitable range.

In silica glass classified as so-called strong glass, a time constant τ (T) of structural relaxation, which is considered to be due to the viscous flow of glass, follows the Arrhenius formula. Therefore, the time constant τ (T) is expressed by the following Formula (1) as a function of the glass temperature T, using a constant A and an activation energy E_{act} determined by the glass composition. In the formula, k_{b} is a Boltzmann constant, and T is the absolute temperature of the glass.

1/τ(T)=A·exp(−E_{act}/k_{b}T) (1)

The above Formula (1) shows that the higher the glass temperature is, the faster the glass structure relaxes and the faster the equilibrium state at the temperature is reached. That is, the higher the glass temperature is, the faster the fictive temperature of the glass approaches the glass temperature.

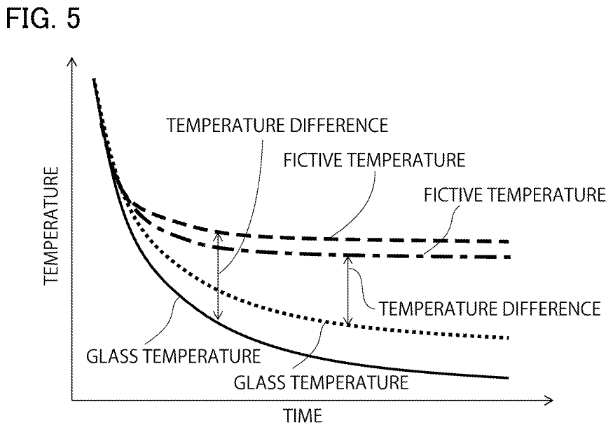

FIG. 5 schematically illustrates how the fictive temperature of the glass constituting the bare optical fiber decreases when the bare optical fiber is slowly cooled according to one or more embodiments. In FIG. 5, the horizontal axis represents time, and the vertical axis represents temperature. In FIG. 5, the solid line indicates the temperature transition of the bare optical fiber under a certain slow cooling condition, and the broken line indicates the transition of the fictive temperature of the glass constituting the bare optical fiber during that time. The dotted line indicates the temperature transition of the bare optical fiber when the cooling rate is made slower than the slow cooling condition indicated by the solid line, and the alternate long and short dash line indicates the transition of the fictive temperature of the glass constituting the bare optical fiber during that time.

When the temperature of the bare optical fiber decreases with time as indicated by the solid line in FIG. 5, the fictive temperature decreases as the temperature of the bare optical fiber decreases as indicated by the broken line. As described above, when the temperature of the bare optical fiber is sufficiently high, the structural relaxation rate of the glass constituting the bare optical fiber is high. However, as the temperature of the bare optical fiber decreases, the structural relaxation rate of the glass decreases, and the fictive temperature can no longer follow the decrease in the temperature of the bare optical fiber. Here, if the cooling rate of the bare optical fiber is moderated, the bare optical fiber will be kept at a relatively high temperature for a long time compared to when the cooling rate is higher. Thus, as indicated by the dotted line and the alternate long and short dash line in FIG. 5, the difference between the temperature of the bare optical fiber and the fictive temperature becomes smaller, and the fictive temperature becomes lower. That is, the structural relaxation of the glass is promoted. Thus, how the structural relaxation of the glass constituting the bare optical fiber can be promoted depends on the temperature history of the bare optical fiber. Therefore, what kind of slow cooling conditions are suitable for reducing the transmission loss of the bare optical fiber will be described below.

The temperature of the bare optical fiber immediately after being drawn from the optical fiber preform is approximately 1800° C. to 2000° C., which is very high. In this process, the time constant τ (T) of the structural relaxation of the glass constituting the bare optical fiber is calculated, for example, using a constant A and an activation energy E_{act} illustrated in Non-patent Literature (K. Saito, et al., Journal of the American Ceramic Society, Vol. 89, pp. 65-69(2006)). Specifically, the time constant τ (T) is about 0.00003 seconds when the temperature of the bare optical fiber is 2000° C. and is about 0.0003 seconds when the temperature of the bare optical fiber is 1800° C. In such a high temperature state, it is considered that the fictive temperature of the glass constituting the bare optical fiber substantially matches the temperature of the bare optical fiber. Therefore, even if the bare optical fiber is slowly cooled in such a high temperature region, the structure of the glass immediately relaxes, so that the effect of the slow cooling is reduced. For this reason, preferably, the bare optical fiber is pre-cooled between the time when the bare optical fiber is drawn and the slow cooling is started as in one or more embodiments, so that the bare optical fiber will be at an appropriate temperature when the slow cooling is started.

Furthermore, the outer diameter of the bare optical fiber drawn from the optical fiber preform is continuously reduced from the outer diameter of the optical fiber preform to a predetermined size. In the case of a typical optical fiber, this predetermined size is, for example, 125 μm. A portion where the outer diameter of the bare optical fiber drawn from the optical fiber preform changes is called a neck-down portion. The temperature T of the bare optical fiber is obtained from the balance of forces at the neck-down portion and the material balance. Specifically, the rate of change of a cross-sectional area S of the neck-down portion of the optical fiber preform in the steady state at a drawing speed v of the bare optical fiber has a relationship with a tension F applied to the bare optical fiber being drawn as illustrated in the following Formula (2), where x is a drawing direction.

v·ds/dx=V·S₀/s₀·dS/dx=−F/β(T) (2)

In the formula, S₀ is the cross-sectional area of the optical fiber preform, s₀ is the nominal cross-sectional area of the bare optical fiber, and V is the delivery speed of the optical fiber preform. β(T) is an elongational viscosity coefficient at the glass temperature T, which is three times a viscosity η. That is, the following Formula (3) is established.

β(T)=3η(T) (3)

Furthermore, the viscosity η of silica glass is obtained by the following Formula (4)

log₁₀{η(T)}=B+C/T (4).

When the viscosity η is expressed in units of [Pa·s], B=−6.37 and C=2.32×10⁴ [K⁻¹] are satisfied. From the above Formula (4), the glass temperature T can be determined from the viscosity η determined by the above Formula (3).

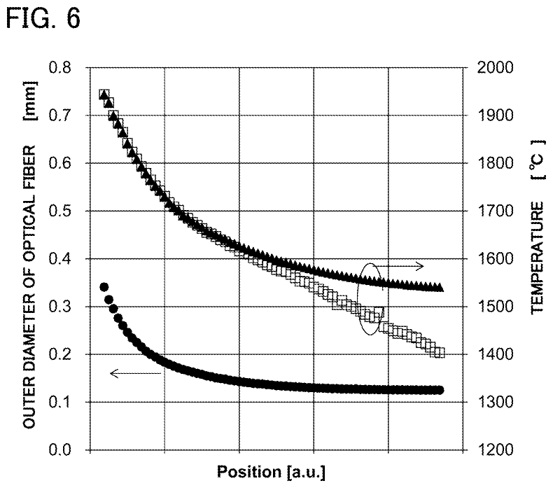

FIG. 6 illustrates relationship among a change in the outer diameter (●) of the neck-down portion of the bare optical fiber under a certain drawing condition, a change in the temperature (□) of the bare optical fiber obtained from the change in the outer diameter of the neck down part, and a change in the fictive temperature (▴) of glass constituting the bare optical fiber obtained from the change in the temperature of the bare optical fiber according to one or more embodiments. It can be seen that as the temperature of the bare optical fiber drops and the viscosity of the glass constituting the bare optical fiber increases, the change in the outer diameter of the bare optical fiber becomes gentler. If the temperature of the bare optical fiber falls below approximately 1650° C., the drop in the fictive temperature of the glass that forms the bare optical fiber can no longer follow the temperature drop of the bare optical fiber, meaning that the temperature difference therebetween starts to increase. In other words, until the temperature of the bare optical fiber drops to approximately 1650° C., the fictive temperature of the glass constituting the optical fiber substantially matches the temperature of the bare optical fiber without slow cooling. This means that the effect of slow cooling is small until the temperature drops to or lower than 1650° C. Thus, slow cooling preferably starts when the temperature is at or lower than 1650° C. In other words, the temperature of the bare optical fiber 1R entering the second portion 112 is preferably 1650° C. or lower.

A longer slow cooling time leads to more structural relaxation of glass constituting the bare optical fiber, enabling an optical fiber with a smaller transmission loss to be manufactured. Still, considering economical conditions regarding productivity and capital investment, the cooling time of the bare optical fiber is preferable 1 second or shorter. According to the calculation of the structural relaxation time constant τ(T) of the glass using a predetermined constant in the above Formula (1), τ(T) of 0.1 second or less is obtained when the glass is approximately 1420° C., τ(T) of 1 second is obtained when the glass is approximately 1310° C., and τ(T) of 10 seconds is obtained when the glass is approximately 1210° C. In view of this, to obtained sufficient effect with slow cooling of the bare optical fiber with the slow cooling time of approximately 1 second, the temperature of the bare optical fiber at the start of the slow cooling is preferably 1300° C. or higher and is more preferably 1400° C. or higher. In other words, the temperature of the bare optical fiber 1R entering the second portion 112 is preferably 1300° C. or higher, and is more preferably 1400° C. or higher.

As described above, a bare optical fiber with a lower temperature requires a longer time for structural relaxation of glass constituting the bare optical fiber. Specifically, when the temperature of the bare optical fiber is below 1150° C., it is difficult to perform structural relaxation of glass with a short slow cooling time. In view of this, the temperature at the end of slow cooling of the bare optical fiber is preferably 1150° C. or higher and lower than 1400° C., and is more preferably 1300° C. or higher. In other words, the temperature of the bare optical fiber 1R exiting the second portion 112 is preferably 1150° C. or higher and lower than 1400° C., and is more preferably 1300° C. or higher.

The time during which the bare optical fiber 1R stays in the second portion 112 is preferably 0.01 seconds or more, and is more preferably 0.05 seconds or more. A longer staying time of the bare optical fiber 1R in the second portion 112 makes it easier for the structure of glass constituting the bare optical fiber 1R to be relaxed. The time during which the bare optical fiber 1R stays in the second portion 112 is preferably 1 second or less, and is more preferably 0.5 seconds or less. With a shorter staying time of the bare optical fiber 1R in the second portion 112, the second portion 112 can be designed to be shorter, so that excessive capital investment can be suppressed. Furthermore, with a shorter staying time of the bare optical fiber 1R in the second portion 112, higher drawing speed can be achieved, so that productivity of the optical fiber can be improved.

Thus, the drawing speed of the bare optical fiber 1R, the wall thickness and the length of the third portion 113, the wall thickness and the length of the second portion 112, the magnitude of the voltage applied to the power feeding units 114a and 114b, and the like are preferably determined in such a manner that the temperature of the bare optical fiber 1R entering the second portion 112 falls within the above range, the temperature of the bare optical fiber 1R exiting the second portion 112 falls within in the above range, and the time during which the bare optical fiber 1R stays in the second portion 112 falls within the above range.

The length of the second portion 112 can be set as follows. The temperature history with the lowest fictive temperature of glass constituting the bare optical fiber 1R depends only on the slow cooling time t. Thus, by obtaining the necessary time t from the fictive temperature with which the target transmission loss of the optical fiber manufactured can be achieved, and determining the drawing speed v while taking productivity into consideration, the necessary length L of the second portion 112 is obtained from the following Formula (5),

t=L/v (5).

<Rapid Cooling Process P4>

After the slow cooling process P3, the bare optical fiber 1R is coated with a coating layer to be the optical fiber 1. The coating layer is for increasing the damage resistance, etc. This coating layer is usually made of an ultraviolet curable resin. Such a coating layer needs to be formed with the bare optical fiber 1R cooled down to a sufficiently low temperature to, prevent burning of the coating layer and the like. The temperature of the bare optical fiber 1R affects the viscosity of the resin to be applied, and consequently affects the layer thickness of the coating layer. The appropriate temperature of the bare optical fiber 1R when forming the coating layer is appropriately determined according to the properties of the resin constituting the coating layer.

In one or more embodiments, the bare optical fiber 1R that has exited from the second portion 112 is rapidly cooled by a cooling device 130. In this process, the bare optical fiber 1R is cooled more rapidly than in the slow cooling process P3. With such a process, the temperature of the bare optical fiber can be sufficiently lowered in a short section, whereby the coating layer can be easily formed. The temperature of the optical fiber exiting the cooling device 130 is, for example, 40° C. to 50° C.

The bare optical fiber 1R cooled down to a predetermined temperature through the cooling device 130 as described above passes through a coating device 141 containing the ultraviolet curable resin to be a coating layer with which the bare optical fiber 1R is to be coated, to be coated with this ultraviolet curable resin. Then, the optical fiber 1R is irradiated with ultraviolet rays while passing through an ultraviolet irradiation device 142, so that the ultraviolet curable resin is cured to be a coating layer, and thus the bare optical fiber 1R turns into the optical fiber 1. The coating layer is usually composed of two layers. The coating layer composed of two layers can be formed as follows. Specifically, the bare optical fiber 1R may be coated with ultraviolet curable resins constituting the respective layers, and then the ultraviolet curable resins may be cured at once, so that the coating layer composed of two layers can be formed. Alternatively, the second coating layer may be formed after the first coating layer is formed. Then, the optical fiber 1 is wound by a reel 152 after having a direction of movement changed by a turn pulley 151.

As described above, the optical fiber drawing furnace heating element 110 according to one or more embodiments includes the heat generating unit 110F including a tubular resistance heating element in which at least a part of the optical fiber preform 1P is disposed in the through-hole 110H. The heat generating unit 110F includes the first portion 111 extending, from a first end portion, over a predetermined section along the longitudinal direction and the second portion 112 positioned closer to a second end portion than the first portion 111 is. The second portion 112 has a wall thickness on a side of the first end portion being equal to or larger than a wall thickness of the first portion 111, the wall thickness of the second portion 112 increasing toward a side of the second end portion from the side of the first end portion.

Thus, with the optical fiber drawing furnace heating element 110, even when voltage is applied to the optical fiber drawing furnace heating element 110 so as to generate heat until the temperature at which the optical fiber preform is drawn in the first portion 111 is reached, the temperature on the first end portion side in the second portion 112 would not exceed the temperature of the first portion 111, and the second portion 112 generates heat with temperature decreasing toward the second end portion side from the first end portion side. Thus, the temperature of the bare optical fiber 1R drawn in the first portion 111 can be gradually lowered in the second portion 112. In other words, the bare optical fiber can be slowly cooled in the second portion 112. The optical fiber drawing furnace heating element 110 according to one or more embodiments includes the first portion 111 in which the bare optical fiber may be thus drawn and the second portion 112 in which the bare optical fiber drawn may be slowly cooled, and thus may achieve the optical fiber drawing furnace 100 with which the optical fiber 1 with a smaller transmission loss can be manufactured with a simpler configuration than that in a case where the drawing furnace and the slow cooling furnace are separately provided.

Thus, the optical fiber drawing furnace 100 according to one or more embodiments including such an optical fiber drawing furnace heating element 110 can perform drawing and slow cooling with a simpler configuration than that in a case where the drawing furnace and the slow cooling furnace are separately provided. Thus, the optical fiber 1 with smaller transmission loss may be manufactured with a simple configuration.

A method for manufacturing the optical fiber 1 according to one or more embodiments includes: the drawing process P1 of drawing the optical fiber preform 1P disposed in the through-hole 110H in the first portion 111; and the slow cooling process P3 of slowly cooling the bare optical fiber 1R, drawn in the drawing process P1, in the through-hole 110H in the second portion 112. Thus, with the method for manufacturing the optical fiber 1 according to one or more embodiments, the drawing and the slow cooling can be performed with a simpler configuration than that in a case where the drawing furnace and the slow cooling furnace are separately provided. Thus, the drawing process P1 and the slow cooling process P3 can be performed with a simple configuration.

In one or more embodiments, the wall thickness of the second portion 112 continuously changes toward the side of the second end portion from the side of the first end portion. With this configuration, the temperature of the second portion 112 is less likely to sharply change locally, compared with a case where the wall thickness of the second portion 112 changes stepwise toward the second end portion side from the first end portion side. The temperature of the bare optical fiber can be controlled to be optimum temperature so that the fictive temperature, indicating the disorderly of the glass structure, can be set to be minimum in accordance with the structural relaxation rate decreasing with the temperature drop of the bare optical fiber.

In one or more embodiments, the second portion 112 has a uniform inner diameter, whereby when the optical fiber drawing furnace heating element 110 is produced, the through-hole of the second portion 112 can be perforated with a generally used drill or the like, whereby the inner circumference surface of the second portion 112 can be easily formed.

In one or more embodiments, the first portion 111 has a uniform wall thickness over the longitudinal direction. Thus, in the first portion 111 in which the optical fiber preform 1P may be drawn into the bare optical fiber 1R, the heat generation with a uniform temperature along the longitudinal direction may be achieved. Thus, a shape known as neck down as a result of the optical fiber preform going through diameter reduction to be the bare optical fiber can be more easily maintained constant. The shape known as neck down depends on the viscosity and the drawing tension of glass in the portion. Thus, with the configuration described above, the outer diameter of the bare optical fiber can be prevented from unnecessarily changing.

In one or more embodiments, the heat generating unit 110F includes the third portion 113 that is provided between the first portion 111 and the second portion 112 and has a wall thickness that is larger than the maximum wall thickness of the second portion 112. Thus, the temperature of the third portion 113 can be lower than those of the first portion 111 and the second portion 112. Thus, the bare optical fiber 1R drawn is pre-cooled in the third portion 113, to be at an appropriate temperature when entering the second portion 112.

In one or more embodiments, the pair of power feeding units 114a and 114b are made of resistance heating elements that are similar to that of the heat generating unit 110F, provided at both ends in the longitudinal direction, and have the wall thickness that are equal to or larger than the maximum wall thickness of the second portion 112. Thus, in one or more embodiments, the power feeding units can be integrally molded with the heat generating unit 110F, whereby the heat generation by the power feeding units 114a and 114b can be suppressed. Thus, the temperature control for the resistance heating in the first portion 111 and the second portion 112 can be suppressed from being difficult. Furthermore, the bare optical fiber 1R and the optical fiber preform 1P can be suppressed from being unnecessarily heated. In one or more embodiments, as described above, the wall thickness of each of the power feeding units 114a and 114b described above is equal to or larger than the maximum wall thickness of the second portion 112. Alternatively, at least one of the power feeding units 114a and 114b can have a wall thickness that is equal to or larger than the maximum wall thickness of the second portion 112. Here, preferably, the wall thickness of the power feeding unit 114b positioned on the second end portion side of the heat generating unit 110F is preferably equal to or larger than the maximum wall thickness of the second portion 112. Thus, the bare optical fiber 1R that has reached a low fictive temperature in the second portion 112 is less likely to be heated again in the power feeding unit 114b on the lower side. Thus, the fictive temperature is less likely to rise. If the wall thickness of the power feeding unit 114b is equal to or larger than the maximum wall thickness of the second portion 112, a portion with a higher temperature than the second portion 112 is on the upper side. Thus, the temperature of the heat generating unit 110F can be monotonically lowered, and thus the temperature of the bare optical fiber 1R can be more monotonically lowered. Here, preferably, the wall thickness of the power feeding unit 114a positioned on the first end portion side of the heat generating unit 110F is preferably equal to or larger than the maximum wall thickness of the second portion 112. In this case, the optical fiber preform 1P can be suppressed from being heated before being uniformly heated in the first portion 111. Thus, one of the parameters that need to be controlled for achieving uniform temperature of the first portion 111 can be eliminated, meaning that the neck-down shape can be more easily maintained constantly. Thus, the outer diameter of the bare optical fiber 1R can be more effectively suppressed from varying unnecessarily, Furthermore, the power feeding units 114a and 114b may have shapes different from those in the above-described embodiments.

The present invention is not limited to the embodiments of the present invention described above as examples.

The configuration of the optical fiber drawing furnace heating element 110 is not limited to that in the above-described embodiments as long as the heat generating unit 110F includes the first portion 111 extending, from a first end portion, over a predetermined section along the longitudinal direction and the second portion 112 positioned closer to a second end portion than the first portion 111 is and the second portion 112 has a wall thickness on a side of the first end portion being equal to or larger than a wall thickness of the first portion 111, the wall thickness of the second portion 112 increasing toward a side of the second end portion from the side of the first end portion. Hereinafter, modifications of the optical fiber drawing furnace heating element 110 will be described. In the following description of the modifications, the description of the same configuration as that of the above-described embodiments will be omitted unless otherwise specified.

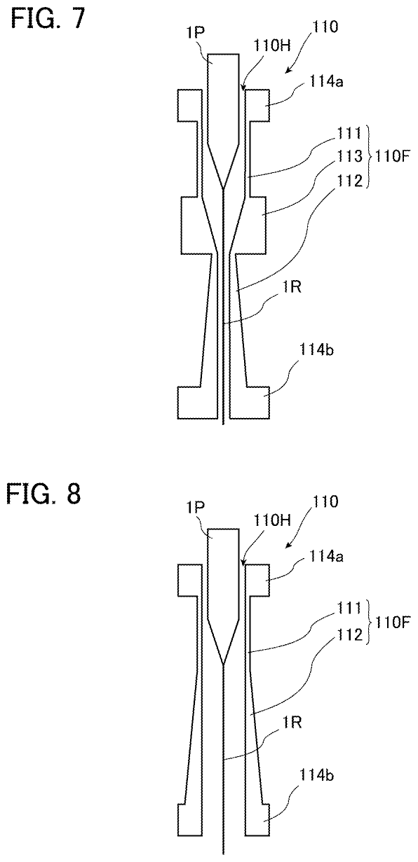

FIG. 7 is a sectional view illustrating a first modification of the optical fiber drawing furnace heating element 110 according to one or more embodiments. As illustrated in FIG. 7, the optical fiber drawing furnace heating element 110 according to the present modification is different from the optical fiber drawing furnace heating element 110 according to the above-described embodiments in that in the third portion 113, an inner diameter closer to the second end portion is smaller than an inner diameter closer to the first end portion. Thus, in the second portion 112, the inner diameter of the second portion 112 is designed to be smaller than that in the second portion 112 of the above-described embodiments, to conform to the inner diameter closer to the second end portion in the third portion 113. As in the above-described embodiments, inert gas is likely to flow in the through-hole 110H of the optical fiber drawing furnace heating element 110. In view of this, with the optical fiber drawing furnace heating element 110 having the configuration described above, the inert gas flowing in the through-hole 110H may be rectified, so that the bare optical fiber 1R drawn can be suppressed from unnecessarily moving.

FIG. 8 is a sectional view illustrating a second modification of the optical fiber drawing furnace heating element 110 according to one or more embodiments. As illustrated in FIG. 8, the optical fiber drawing furnace heating element 110 according to the present modification is different from the optical fiber drawing furnace heating element 110 according to the above-described embodiments in that the third portion 113 is not formed. The optical fiber drawing furnace heating element 110 having the configuration according to the present modification can have a simple configuration. The configuration with the third portion 113 not formed as in the present modification is particularly preferable in a case where the pre-cooling process P2 is not required meaning that the third portion 113 is not required.

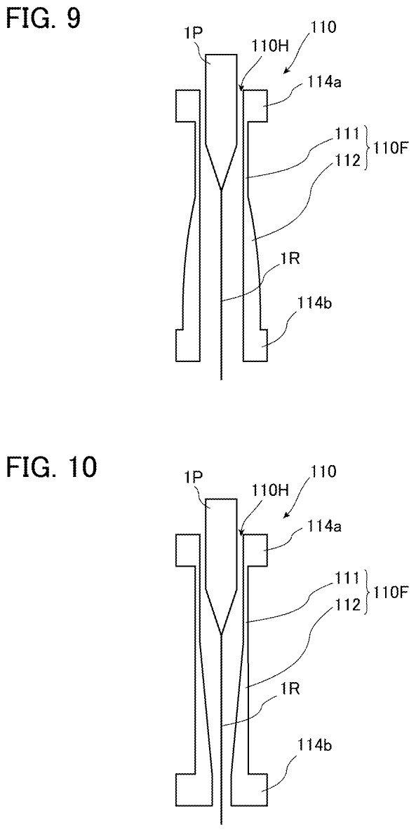

FIG. 9 is a sectional view illustrating a third modification of the optical fiber drawing furnace heating element 110 according to one or more embodiments. As illustrated in FIG. 9, the optical fiber drawing furnace heating element 110 according to the present modification is different from the optical fiber drawing furnace heating element 110 according to the second modification described above in that the wall thickness of the second portion 112 changes at a smaller rate at a portion closer to the second end portion. With the optical fiber drawing furnace heating element 110 having the configuration according to the present modification, the current density can be gradually decreased toward the second end portion side the second portion 112, and thus the temperature can be gradually lowered toward the second end portion side of the second portion 112. Accordingly, the temperature of the bare optical fiber 1R can be lowered more gradually at a portion closer to the end of the process of slowly cooling the bare optical fiber 1R. Thus, the temperature drop of the bare optical fiber may be gradually controlled so that the fictive temperature, indicating the disorderly of the glass structure, can be set to be minimum in accordance with the glass structural relaxation rate decreasing with the temperature drop of the bare optical fiber.

FIG. 10 is a sectional view illustrating a fourth modification of the optical fiber drawing furnace heating element 110 according to one or more embodiments. As illustrated in FIG. 10, the optical fiber drawing furnace heating element 110 according to the present modification is different from the optical fiber drawing furnace heating element 110 according to the second modification described above in that in the second portion 112, an inner diameter closer to the second end portion is smaller than an inner diameter closer to the first end portion and that the second portion 112 has a uniform outer diameter. With the present modification, similarly to the first modification, even when inert gas flows into the through-hole 110H of the optical fiber drawing furnace heating element 110, the inert gas flowing into the through-hole 110H may be rectified, so that the bare optical fiber 1R drawn can be suppressed from unnecessarily moving.

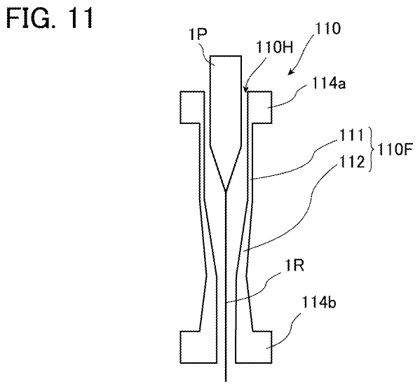

FIG. 11 is a sectional view illustrating a fifth modification of the optical fiber drawing furnace heating element 110 according to one or more embodiments. As illustrated in FIG. 11, the optical fiber drawing furnace heating element 110 according to the present modification is mainly different from the optical fiber drawing furnace heating element 110 according to the fourth modification described above in that the second portion 112 has a uniform inner diameter from an intermediate point toward the second end portion from the first end portion. Furthermore, in the present modification, the outer diameter of the second portion 112 is not uniform. Specifically, in a portion of the second portion 112 where the inner diameter decreases toward the second end portion side from the first end portion side, the outer diameter of the second portion 112 decreases toward the second end portion side from the first end portion side. Furthermore, in a portion of the second portion 112 where the inner diameter is uniform, the outer diameter of the second portion 112 increases toward the second end portion side from the first end portion side. With the present modification with the inner diameter of the second portion 112 being smaller on the second end portion side than on the first end portion side, and being uniform from an intermediate point toward the second end portion from the first end portion, the inner diameter of the second portion can be reduced to be suitable for a shape known as neck down as a result of the optical fiber preform drawn to go through diameter reduction to be the bare optical fiber. Thus, the inert gas flowing in the through-hole may be more effectively rectified, so that the bare optical fiber drawn can be more effectively suppressed from unnecessarily moving.

Although not specifically illustrated or described, for example, the wall thickness of the second portion 112 may increase stepwise toward the second end side from the first end side. Furthermore, the wall thickness of the second portion 112 may increase at a larger change rate at a portion closer to the second end. Furthermore, in these modifications and the third to the fifth modifications, the third portion 113 as described in the above-described embodiments and the first modification may be provided between the first portion 111 and the second portion 112.

Furthermore, in the above-described embodiments and modifications, the wall thickness of the first portion 111 may not be uniform in the longitudinal direction. For example, the wall thickness of the first portion 111 may decrease toward the second end side from the first end side.

As described above, the present invention can provide an optical fiber drawing furnace heating element, an optical fiber drawing furnace, and a method for manufacturing an optical fiber that may achieve an optical fiber drawing furnace that may manufacture an optical fiber with a smaller transmission loss with a simple configuration, and thus can be used for a field involving manufacturing of an optical fiber for optical fiber communications. It can also be used in the field of manufacturing optical fiber laser devices and other devices using optical fibers.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An optical fiber drawing furnace heating element comprising:
a heat generator including:
a tubular resistance heating element in which at least a part of an optical fiber preform is disposed in a through-hole;
a first portion extending, from a first end portion of the heat generator, over a predetermined section along a longitudinal direction of the optical fiber drawing furnace heating element; and
a second portion disposed closer to a second end portion of the heat generator than the first portion, wherein
the second portion has a wall thickness on a side of the first end portion being equal to or larger than a wall thickness of the first portion, and
the wall thickness of the second portion increases toward a side of the second end portion from the side of the first end portion.

2. The optical fiber drawing furnace heating element according to claim 1, wherein
the wall thickness of the second portion continuously changes toward the side of the second end portion from the side of the first end portion.

3. The optical fiber drawing furnace heating element according to claim 2, wherein
the wall thickness of the second portion changes at a smaller rate at a portion closer to the second end portion than a portion farther from the second end portion.

4. The optical fiber drawing furnace heating element according to claim 1, wherein
the second portion has a uniform inner diameter.

5. The optical fiber drawing furnace heating element according to claim 1, wherein
in the second portion, an inner diameter closer to the second end portion is smaller than an inner diameter closer to the first end portion.

6. The optical fiber drawing furnace heating element according to claim 5, wherein
the second portion has a uniform outer diameter.

7. The optical fiber drawing furnace heating element according to claim 5, wherein
the second portion has a uniform inner diameter from an intermediate point toward the second end portion from the first end portion.

8. The optical fiber drawing furnace heating element according to claim 1, wherein
the first portion has a uniform wall thickness over the longitudinal direction.

9. The optical fiber drawing furnace heating element according to claim 1, wherein
the heat generator includes a third portion that is disposed between the first portion and the second portion and that has a wall thickness larger than the wall thickness of the second portion on the side of the first end portion.

10. The optical fiber drawing furnace heating element according to claim 9, wherein
in the third portion, an inner diameter closer to the second end portion is smaller than an inner diameter closer to the first end portion.

11. The optical fiber drawing furnace heating element according to claim 1, further comprising:
a pair of power feeds that include the resistance heating element and that are provided at both ends of a tubular shape of the heat generator in the longitudinal direction, wherein
one of the power feeds that is on the side of the second end portion of the heat generator has a wall thickness that is equal to or larger than a maximum wall thickness of the second portion.

12. An optical fiber drawing furnace comprising:
the optical fiber drawing furnace heating element according to claim 1.

13. A method for manufacturing an optical fiber using the optical fiber drawing furnace according to claim 12, comprising:
drawing the optical fiber preform disposed in the through-hole in the first portion in the optical fiber drawing furnace heating element of the optical fiber drawing furnace; and
cooling a bare optical fiber, drawn from the optical fiber preform, in the through-hole in the second portion in the optical fiber drawing furnace heating element.

14. The method according to claim 13, wherein
a temperature of the bare optical fiber entering the second portion is greater than or equal to 1300° C. and is less than or equal to 1650° C., and
a temperature of the bare optical fiber exiting from the second portion is greater than or equal to 1150° C. and is less than 1400° C.

15. The method according to claim 13, wherein
a cooling time of the bare optical fiber in the second portion is 0.05 seconds or more.

16. The method according to claim 13, wherein
a cooling time of the bare optical fiber in the second portion is 1 second or less.

17. The method according to claim 13, wherein
the heat generator includes a third portion that is disposed between the first portion and the second portion and has a wall thickness that is larger than the wall thickness of the second portion on the side of the first end portion, and
the method further comprises:
pre-cooling the optical fiber, with the third portion, to a predetermined temperature before the optical fiber enters the second portion.
